(19) United States
(12) Patent Application Publication
(10) Pub. No.: US 2024/0252861 A1
(43) Pub. Date: Aug. 1, 2024

(54) Extinguishing Assembly and Method for Extinguishing Fire on or Cooling a Parked Vehicle

(71) Applicants: Anton Niederberger, Oberdorf NW (CH); Marcel Amann, Luzern (CH); Stefan Sandmann, Ilmenau (DE)

(72) Inventor: Stefan Sandmann, Ilmenau (DE)

(21) Appl. No.: 18/561,731

(22) PCT Filed: May 18, 2022
(86) PCT No.: PCT/DE2022/100377

§ 371 Date: Nov. 17, 2023

(30) Foreign Application Priority Data
May 19, 2021 (DE) 102021113050.6
Jul. 24, 2021 (DE) 102021119209.9

(51) Int. Cl. A62C 3/07; A62C 35/02; E04H 6/42

(52) U.S. Cl. CPC A62C 3/07; A62C 35/02; E04H 6/42

(57) ABSTRACT

The task of the present invention is to provide an extinguishing arrangement for a vehicle which, in the event of a fire or need, surrounds the respective vehicle or electric vehicle in such a way that extinguishing agent is used directly and only in a limited space, thereby surrounding or flooding the vehicle and thus the source of the fire as required up to completely with extinguishing agent and also preventing an arbitrary or uncontrolled outflow of the extinguishing agent and at the same time restricting parking only slightly.

Extinguishing arrangement for parked vehicles (1), in particular for electric vehicles, wherein the respective vehicle (1) is parked or can be parked on a parking space (2), wherein a wall arrangement (3) can be erected around the vehicle, which is designed to surround or enclose the vehicle (1) at least laterally in such a way to receive and/or retain an extinguishing agent (4) at least in the enclosed area and to surround and/or flood the vehicle (1) with the extinguishing agent (4) at least in certain areas, and in that the wall arrangement (3) is designed to enclose the vehicle (1) at least laterally starting from a standby position in a required position,
characterized in
   that the wall arrangement (3) in the standby position is recessed at least partially or in sections in the parking space (2) or is arranged laterally below the parking space and can be pushed, pulled, rolled out and/or folded out vertically or upwards into the required position by means of an adjusting device or by filling from the parking space (2) or from the side of the parking space (2)
or
   that the wall arrangement (3) comprises at least two modules (12) as a mobile variant, the modules (12) each having a floor profile (17) resting on the parking space (2) and at least two modules (12) extending upwards from the floor profile (17) in the manner of a wall and being preassembled, at least two modules (12) being movable or liftable laterally around the vehicle (1) from the standby position into the required position and being lowerable onto the parking space (2) and being connectable to one another.

### CROSS REFERENCE TO RELATED APPLICATIONS

This application is the U.S. national stage of International Application No. PCT/DE2022/100377, filed on 2022 May 18. The international application claims the priority of DE 102021113050.6 filed on 2021 May 19 and the priority of DE 102021119209.9 filed on 2021 Jul. 24; all applications are incorporated by reference herein in their entirety.

### BACKGROUND

The invention relates to an extinguishing arrangement, which can also be referred to as an extinguishing agent retention arrangement, for vehicles; in particular, those parked or abandoned or evacuated or involved in an accident, in particular, electric vehicles, for example, in the open air, in buildings, parking garages, underground garages, parking halls, tunnels, under bridges or underpasses, ships, ferries, trains or on parking areas or other surfaces or in other areas, with an extinguishing arrangement or extinguishing agent retention arrangement surrounding the vehicle at least laterally. For the sake of simplicity, only extinguishing arrangement or extinguishing agent retention arrangement is used in the following.

Furthermore, the invention comprises a procedure for extinguishing or cooling a vehicle parked or at a standstill.

In particular, the invention is intended to ensure that, when extinguishing fires on and/or in vehicles, the respective vehicle or, at least the source of the fire is enclosed as completely as possible by the extinguishing agent and, if necessary, the vehicle or the respective energy storage device can be flooded or submerged with the extinguishing agent and the extinguishing agent is thereby restrained from spreading in an uncontrolled manner.

Electromobility is currently on the rise, which is leading to a change in the transportation sector. The increased number of electric vehicles parked or at a standstill particularly in underground car parks or other areas, is creating new problems. Safety specialists have major safety concerns in the event of a battery fire in an electric vehicle. One possible solution for extinguishing or cooling a burning electric vehicle is to store the electric vehicle in a container filled with a suitable extinguishing agent for 48 hours.

In the event of an electric vehicle fire in an underground garage or in structures such as tunnels, under bridges or underpasses, especially without a pre-installed extinguishing system, new solutions are urgently needed. It is not possible for the emergency services and fire department to intervene in the event of a battery fire. The reason for this is a high temperature generated when the battery burns endangering the building fabric and leading to structural weaknesses. For example, the reinforcing steel in the concrete support structure of the underground garage can fail. It is currently forbidden for emergency services and the fire department to intervene in the event of a fire in these parking garages and underground garages. In extreme cases, a building can collapse.

DE102019003289A1 discloses a fire extinguishing device for extinguishing a motor vehicle fire, wherein the fire extinguishing device comprises a device floor for parking a motor vehicle and a device wall which is connected to the device floor. In a state of use, the device wall together with the device floor forms a container, the container interior of which is designed to hold the motor vehicle and to hold extinguishing medium for extinguishing the motor vehicle fire, wherein the device wall can be expanded from a state of non-use into the state of use by introducing the extinguishing medium. Further, the fire extinguishing device comprises a nozzle element arranged on the device wall and configured to guide the extinguishing medium from the wall interior into the container interior.

JPH0679010A discloses various bulkheads for vehicles parked in a parking device. For example, roller shutters are provided which seal off the burning vehicle or enclose the parking area of the vehicle in the event of a fire. A shutter can also be lowered or a laterally displaceable curtain can be provided to enclose the parking area of the vehicle.

WO2018222046A1 discloses a device for extinguishing fires in energy storage systems of electrically powered vehicles, wherein walls are placed around the vehicle to form a basin that can be filled with water to cool the temperature in the batteries, stop thermal runaway and extinguish the fire. The device also keeps the waste extinguishing agent containing toxic substances and electricity safely away from the emergency services during firefighting and provides the ability to collect the waste extinguishing agent afterwards to the proper disposal.

WO2020253909A1 discloses a fitting for firefighting and/or for cooling burning objects, which is pushed or arranged under the vehicle or electric vehicle and sprinkles the respective vehicle from below and thus extinguishes a burning battery or cools a battery that may catch fire.

DE202017002156U1 discloses a surface sprinkler pipe for firefighting. DE202020103375U1 discloses an extinguishing container into which the vehicle to be extinguished is to be pulled. The disadvantage is the complex construction, which is also difficult to transport to the scene of the fire if necessary.

### SUMMARY

Extinguishing arrangement and procedure for extinguishing or cooling a vehicle parked or at a standstill

The task of the present invention is to provide an extinguishing arrangement for a vehicle which, in the event of a fire or need, surrounds the respective vehicle or electric vehicle in such a way that extinguishing agent is used directly and only in a limited space, thereby surrounding or flooding the vehicle and thus the source of the fire as required up to completely with extinguishing agent and also preventing an arbitrary or uncontrolled outflow of the extinguishing agent and at the same time restricting parking only slightly.

Extinguishing arrangement for parked vehicles (1), in particular for electric vehicles, wherein the respective vehicle (1) is parked or can be parked on a parking space (2), wherein a wall arrangement (3) can be erected around the vehicle, which is designed to surround or enclose the vehicle (1) at least laterally in such a way to receive and/or retain an extinguishing agent (4) at least in the enclosed area and to surround and/or flood the vehicle (1) with the extinguishing agent (4) at least in certain areas, and in that the wall arrangement (3) is designed to enclose the vehicle (1) at least laterally starting from a standby position in a required position, characterized in
that the wall arrangement (3) in the standby position is recessed at least partially or in sections in the parking space (2) or is arranged laterally below the parking space and can be pushed, pulled, rolled out and/or folded out vertically or upwards into the required position by means of an adjusting device or by filling from the parking space (2) or from the side of the parking space (2) or
that the wall arrangement (3) comprises at least two modules (12) as a mobile variant, the modules (12) each having a floor profile (17) resting on the parking space (2) and at least two modules (12) extending upwards from the floor profile (17) in the manner of a wall and being preassembled, at least two modules (12) being movable or liftable laterally around the vehicle (1) from the standby position into the required position and being lowerable onto the parking space (2) and being connectable to one another.

### DETAILED DESCRIPTION

The task of the present invention is to provide an extinguishing arrangement for a vehicle which, in the event of a fire or need, surrounds the respective vehicle or electric vehicle in such a way that extinguishing agent is used directly and only in a limited space, thereby surrounding or flooding the vehicle and thus the source of the fire as required up to completely with extinguishing agent and also preventing an arbitrary or uncontrolled outflow of the extinguishing agent and at the same time restricting parking only slightly.

The object of the invention is solved by creating an extinguishing arrangement for stationary, for example, vehicles parked or at a standstill; in particular, for electric vehicles, wherein the respective vehicle stands or can be parked on a parking space, wherein a wall arrangement can be erected around the vehicle on the parking space, at least in certain areas or in sections, which are designed to surround or enclose the vehicle, at least laterally, i.e., at least at the front, rear, right and left in relation to the vehicle, in such a way as to receive and/or retain an extinguishing agent, at least in the enclosed area or in the area enclosing the vehicle and to surround and/or flood the vehicle with the extinguishing agent, at least in certain areas. Starting from a standby position in a required position, the wall arrangement is designed to enclose the vehicle, at least laterally, wherein, according to the invention, the wall arrangement is recessed in the standby position, at least partially or in sections in the parking space or is arranged laterally below the parking space and can be pushed, pulled, rolled out and/or unfolded vertically or upwards into the required position by means of an adjusting device or by filling from the parking surface or from the side of the parking surface.

Advantageously, the wall arrangement is designed to enclose the vehicle, at least laterally starting from a standby position in a required position.

This can be done or triggered manually or automatically by means of an adjusting device. Areas can be provided and designed accordingly. In this way, a movement path can also be determined, at least approximately on the basis of the standby position and the required position, so that it is possible for the wall arrangement to be moved easily from the standby position to the required position without the movement of the wall arrangement being disturbed by the vehicle or the wall arrangement colliding with the vehicle or parts of the vehicle during movement. It is also possible to specify when and how a vehicle can or should be parked on the parking space.

In the standby position, the wall arrangement, which is designed to be flexible, for example, is stored rolled up or folded up or collapsed, for example, in or on the edge of the parking space or in a corresponding box arranged in or under the parking space and, when required, is brought into the required position, for example, by a corresponding adjusting device at the side of the parking space to fulfill its function.

At least one linear drive, a toothed rack or spindle drive, a hydraulic cylinder, a pneumatic cylinder, a cable pull, a chain, a telescopic rod or a movable scissors-lift mechanism, as well as combinations, can be considered as an adjusting device. The adjusting device can also be used as or with a preloaded spring, for example.

Advantageously, the corresponding wall arrangement can be moved manually or automatically by means of the adjusting device or can only be triggered if the wall arrangement independently encloses or can enclose the vehicle. Automatic triggering and movement is particularly advantageous for unattended areas.

Thanks to the adjusting device coupled with a sensor system, the wall arrangement can be moved quickly from the standby position to the required position if necessary. The rapid, preferably sensor-controlled and thus automatic or automatable erection of the wall arrangement surrounding the vehicle can advantageously prevent the source of the fire or potential source of the fire and the outflow of extinguishing agent. This allows the fire to be contained quickly, the spread of the fire to other vehicles or the surrounding area or a building and the impact on the building and the surrounding area to be prevented or, at least reduced. It can also prevent or, at least minimize damage to them.

Alternatively, the wall arrangement comprises, at least two modules as a mobile variant, whereby the modules each have a floor profile resting directly on the parking space and, at least two modules extend upwards from the floor profile in a wall-like manner and are pre-assembled, whereby, at least two modules can be moved or lifted from the standby position laterally around the vehicle into the required position on the parking space and can be set down on the parking space and connected to each other. In the standby position, for example, at least two modules prepared or set up in preparation at the place of use are away from or at a safe distance from the vehicle, while in the required position, for example, at least two modules are arranged around the vehicle.

The floor profile can be made in several parts and can be assembled.

One module of the mobile variant can have a hinged or pivoting wall section. This also allows vehicles to be moved in or out without having to dismantle or remove the wall arrangement as a mobile variant.

In this way, the extinguishing system can be used with little effort around a vehicle at almost any accessible location, even outside buildings. Thanks to a multi-part design in modules, the modules can simply be arranged laterally around the vehicle without having to lift them over the vehicle, for example. The vehicle can be a small vehicle such as a one-lane vehicle or a commercial vehicle such as a truck. The frame, the wall arrangement and the connections must be designed accordingly.

For example, two U-shaped modules or two or four L-shaped modules or mixed forms can be considered for use, or U-shaped and/or L-shaped modules are provided or prepared accordingly, when being arranged result in an extinguishing arrangement that encloses the respective vehicle.

This reliably encloses the sides of the vehicle. Extinguishing agent cannot leak or can only leak to a limited extent. The wall arrangement is connected or, at least in contact with the parking space by, at least touching or abutting. This also includes fastening or anchoring or a force-fit or form-fit connection of the wall arrangement to or with the parking space.

A parking space is understood to be all surfaces or areas with a floor, such as, for example, non-final outdoor areas, buildings, parking garages, underground garages, parking halls, tunnels, under bridges or underpasses, in or on ships, ferries, trains or on parking areas or other surfaces or in other areas in or on which vehicles can stand or be parked or left standing. This may include, for example, vehicles that are not parked, parked or abandoned, defective, involved in an accident or evacuated.

In the event of a fire or if necessary, an, at least partially movable wall arrangement can be placed, at least to the side of the vehicle. The wall arrangement can be in one piece or consist of several sections or modules that can be moved or moved separately. The wall arrangement or the sections or modules can thus be moved or driven around the vehicle, which has been driven onto the parking space or parked or left standing for any reason, whereby this area or location or the space is understood as the parking space, in the event of a fire or if necessary. In the event of a fire or if necessary, the vehicle is enclosed by the wall arrangement, at least laterally up to a floor, for example, that of the parking space, so that the extinguishing agent cannot run off. The parking space is therefore the reference area or permissible parking area for the vehicle, for the use of the respective wall arrangement and/or not to impair the use of the respective wall arrangement.

A case of need is understood to be, for example, the development of smoke or heat or a gas detection indicating an imminent or developing fire.

It is possible that the wall arrangement forms an enclosure, i.e. is also closed on the side above the vehicle. Similarly, with a corresponding parking space, the wall arrangement can also enclose the vehicle on all sides.

Depending on the wall arrangement, it is advantageous that a sealing to the parking space is provided. Depending on the wall arrangement and configuration or design, a sealing or sealing effect can be formed directly or indirectly during use.

The wall arrangement surrounding the side of the vehicle thus prevents the extinguishing agent used from flowing off to the side in the event of a fire or if necessary. Accordingly, the extinguishing agent is retained by the wall arrangement so that the vehicle remains as completely enclosed as possible by the extinguishing agent and, if necessary, can also be flooded with the extinguishing agent.

The wall arrangement, which is movable, at least in sections, makes it possible to provide the entire wall arrangement or the separately movable sections in such a way that the vehicle can be driven up to the parking space and, if necessary, can get in and out comfortably. For example, three sections can be permanently installed as wall sections of the wall arrangement of the extinguishing arrangement and a movable section according to the invention can be arranged as a wall section in the area of the access/exit. The wall arrangement or the separately movable sections can thus change from a position that allows the vehicle to enter to a position where there is a need to retain the extinguishing agent.

However, it may also be provided that the wall arrangement is recessed into the parking space all the way around or continuously laterally, i.e., at least at the front, rear, right and left in relation to the vehicle, or is arranged laterally below the parking space and can be pushed, pulled, rolled out and/or folded out vertically or upwards out of the parking space or to the side of the parking space.

Due to the retention of the extinguishing agent possible with the device according to the invention, the fire can be fought effectively and locally limited; in particular, the vehicle or the source of the fire can be quickly surrounded by the extinguishing agent. This also very effectively counteracts the spread of the fire and reduces the damage to nearby vehicles or the respective building or structure or the environment or the fire department. At the same time, the prevented discharge saves extinguishing agent and the respective surroundings and the environment as well as the fire department are less affected and the cleaning effort is reduced.

To solve the problem of the invention, the invention also provides a method for extinguishing or cooling a vehicle parked or at a standstill, in particular, an electric vehicle, wherein the respective vehicle is parked on a parking space.

Advantageously, the method can be carried out using the extinguishing arrangement according to the invention.

In the procedure, when a fire or an excess temperature or smoke development or a gas detection indicating an imminent or developing fire is detected, a wall arrangement is erected or positioned, at least in certain areas around the vehicle parked on the parking space and the vehicle is enclosed, at least laterally. The area enclosed by the wall arrangement is flooded with an extinguishing agent and the extinguishing agent surrounds the vehicle and/or floods the vehicle, at least in certain areas, whereby the wall arrangement is moved, at least in sections from a standby position to a required position and the vehicle is enclosed, at least laterally.

According to the invention, the wall arrangement is pushed, pulled, rolled out and/or unfolded vertically or upwards into the required position from the standby position, at least in certain areas or in sections by means of a adjusting device or by filling from the parking space or from laterally below the parking space.

Alternatively, according to the invention, at least two modules of the wall arrangement are moved or lifted as a mobile variant from the standby position onto the parking space laterally from different directions against or around the vehicle into the required position, whereby the vehicle is laterally enclosed, and are set down onto the parking space and connected to one another.

With regard to electric vehicles, in particular, all battery-powered or hybrid battery-powered vehicles are understood. This includes all one-lane, two-lane and three-lane battery-powered or hybrid battery-powered vehicles. For example, this includes electric cars, electric commercial vehicles, electric trucks, electric bicycles, electric motorcycles, electric scooters, electric mopeds and electric tricycles.

The extinguishing system must be dimensioned and/or designed according to the vehicle type or size. Depending on the requirements, the different designs can be scaled and adapted to the specific vehicle.

Although the focus is on electric vehicles, this does not exclude all other vehicles or vehicles powered in other ways.

The extinguishing system is also suitable for other vehicles with a different or alternative energy source or an energy carrier for the drive or for vehicles powered in other ways. This also includes vehicles with as yet unknown drive systems or energy sources.

In simplified terms, the term ‘vehicles’ is therefore used.

Suitable extinguishing agents and/or coolants include water, foam and/or sand or other well-dispersing extinguishing agents. Furthermore, additives are conceivable which qualify unsuitable extinguishing agents so that they can be used afterwards. An additive is, for example, a wetting agent added to the extinguishing water so that it is subsequently suitable for extinguishing fires in or on lithium-ion batteries or other electrical energy sources or accumulators. Different extinguishing agents can also be combined if the situation or the environment requires or permits it. In simplified terms, extinguishing agents include different variants or combinations to extinguish a fire or to cool the fire or electric vehicle and, if necessary, the surrounding area.

Preferred designs of the invention are given in the dependent claims.

Advantageously, the wall arrangement is in one or more parts and comprises wall sections or an enclosure or a curtain or a hose or a foil bag or a foil, so that extinguishing arrangements are created for different locations, parking spaces or static requirements, special design features or different fire classes. The design can also be adapted to the requirements and resistance depending on the wall arrangement. Different versions of the wall arrangement can also be combined or a design made up of several parts can be created. The design consisting of several parts can be separated or assembled directly or via connecting elements. For example, wall sections can be combined to form a multi-part wall arrangement and connected in a movable, rigid, fixed or detachable manner.

In an advantageous further development, wall sections of the wall arrangement can be coupled or connected via profiles in which the wall sections are guided or can be guided or arranged. The transition between the respective wall section and the respective profile also forms a sealing. The profiles can be arranged in corners of a quadrilateral or polygon. These profiles extend, at least into or onto the parking space or are arranged in or on the parking space.

In an preferred design of the invention, it is provided that, in addition, a wall arrangement, at least in certain areas or in sections, for example, as individual or connected wall sections, can be extended or unrolled, folded down, unfolded and/or folded out from above, i.e. from or from a ceiling or support arranged above the parking space or a frame vertically downwards or downwards or down to or into the floor. A wall arrangement made of flexible material, for example, is stored in the standby position, for example, on the ceiling above the parking space in a box arranged there, rolled up, folded or folded up and, when required, is brought into the required position by a corresponding adjusting device at the side of the parking space to fulfill its function, for example, by guiding it up to the wall arrangement coming from or to the side of the parking space or up to the floor or, advantageously, into a groove arranged in the floor for sealing.

According to a further advantageous further development, the wall arrangement can be extended or rolled out, folded out and/or folded down laterally or horizontally around the vehicle, at least in some areas or in sections, for example, as individual or connected wall sections. Accordingly, the vertically arranged wall arrangement can be displaced laterally or horizontally by means of an adjusting device so that the wall arrangement is guided around the vehicle as far as the ground, thus advantageously preventing the extinguishing agent from flowing off.

According to a further advantageous effect, the wall arrangement can be pulled out, unrolled, folded out and/or folded down over the vehicle, at least in certain areas or sections, so that the vehicle can be enclosed at the top and the fire can thus be spatially limited.

These aforementioned further effects for wall arrangements can be combined as required, which means that the respective vehicles can be enclosed more reliably and the extinguishing agent can also be retained more reliably. For example, a wall arrangement can be provided from above and from below, which meet or overlap away from the ceiling and the parking space.

These aforementioned further effects for wall arrangements can be designed in combination as a combined, one-piece or complex wall arrangement, which in turn enclose the respective vehicle accordingly. For example, channel-like, tube-like or hose-like wall arrangements can be considered.

For multi-part combined wall arrangements, bulkheads or connecting elements are used at the joints or connection points or overlapping points of the respective wall arrangements for reliable and automatic sealings and connection. For example, disposable elements can also be used as bulkheads or connecting elements, which may have to be opened destructively to recover the vehicle after extinguishing or fighting the fire, as the wall arrangement may also have to be replaced or repaired as a result of the fire.

According to a preferred design of the invention, the wall arrangement is rigid or stiff or foldable or hinged. This includes individual rigid or stiff wall sections connected to each other in a hinged or foldable manner, for example, by means of hinges or via flexible transitions. Bulkheads are advantageously provided at the joints and towards the floor.

Rigid or rigid wall arrangements include, for example, metal plates or plates made of suitable synthetic materials or flat or plate-like composite materials that are not only mechanically resistant but also thermally resistant.

However, the wall arrangement can also be flexible or foldable or easy to wind. In this case, the wall arrangement can be single-walled or, at least double-walled or have, at least one internal hollow chamber. A single-walled wall arrangement allows a simple and lightweight construction. The double-walled wall arrangement can be filled to improve or increase the stability of the wall arrangement and, depending on the design of the wall arrangement, the tightness to each other and to the parking space. Different fillings can be provided by means of inner chambers. For example, extinguishing agents, water, sand and/or compressed air or another gas or an extinguishing gas can be used as a filling.

Advantageously, this double-walled design of the wall elements, realized with flexible wall material, is designed with interconnected internal hollow chambers. Water or an extinguishing agent can be filled into the hollow chambers between the two outer walls of the double-walled, flexible wall material. As a result, these tubular or bag-like wall arrangement elements are pulled downwards due to their weight and pressed against or into the floor, thus promoting sealing to the floor.

Flexible wall materials include, for example, films or tarpaulins or flat composite materials which, in addition to mechanical resistance or strength, also have thermal resistance. In addition, the films or tarpaulins or composite materials can, for example, have coatings or integral or attached reinforcements, such as a metal mesh, which promote mechanical resistance and thermal resistance.

Alternatively and additionally, the wall arrangement has support structures, reinforcements or stiffeners or coatings, which increase stability and strength. Advantageously, the flexible wall material can be made of a reinforced material composite or reinforcements/stiffeners can be arranged on the outside of the flexible wall material. The reinforcement can, for example, take the form of fabric material or fiber material or metal wires or metal mesh integrated into the wall material in the direction of the greatest load.

Support structures, for example, in the form of struts or rods, and reinforcements, for example, in the form of lattice structures or supporting structures, can also be provided in or on the wall arrangement.

A separate reinforcement or stiffener arranged outside the sealing flexible wall material, which absorbs the compressive forces, can also be advantageously used here.

Alternatively and additionally, there are support structures, reinforcements or stiffeners independent of the wall arrangement, which indirectly support and/or stabilize the wall arrangement, separately and/or outside the flexible wall material, for example, the sealing flexible wall material, and absorb compressive forces.

The flexibility of the wall material enables good adaptation to the floor and, accordingly, sealing to the floor. The material used here can be, for example, rubberized or silicone-coated fabric or a mineral fiber fabric or a reinforced film, for example, reinforced with metal fabric. In addition to the preferred mechanical resistance, the fabric and film are preferably also fireproof or at least flame-retardant or highly heat-resistant. Depending on the application, the mechanical resistance or the flame-retardant or highly heat-resistant properties may predominate.

In addition, flexible wall material can be easily folded or rolled up or folded and thus stowed away in a very space-saving manner in the standby position.

According to a preferred design of the invention, it is provided that the parking space has a groove-like recess, a platform and/or a double bottom at least in some areas, wherein the wall arrangement, which can be pulled out, unrolled, unfolded and/or folded out upwards, is provided in the groove-like recess, in, on or under the platform and/or in the double bottom and/or the wall arrangement, which can be pulled out, unrolled, unfolded and/or folded out or dropped out, for example, from above or laterally or horizontally, can be fastened, fixed or guided. This advantageous design makes it possible to anchor or guide the wall arrangement in the required position in the floor and, thanks to the additional positive fit, to better seal the wall arrangement to the floor. Furthermore, the flexibly designed wall arrangement can advantageously be stowed underneath the parking space of the vehicle in the standby position, for example, under the platform or in the double floor or in the groove-like recess.

Furthermore, it is advantageously provided that a ramp leading to the parking space is present, whereby the ramp can be independent of the parking space or part of the wall arrangement. A ramp is particularly necessary if the parking space of the vehicle is designed as a platform, i.e. raised, or if a groove has to be driven over to be able to drive onto the parking space. The ramp can be flap-like and thus advantageously also be designed as a wall section of the wall arrangement. Advantageously, driving onto or over the wall arrangement can be prevented to avoid damage to the wall arrangement.

The retention of the extinguishing agent is facilitated by the fact that the wall arrangement or the respective module or floor profile can be sealed or sealed to the parking space or is connected to the parking space. This also reduces the extinguishing agent requirement. Depending on the sealing, the associated friction also favors the positional stability of the wall arrangement.

The wall arrangement or the respective module or the respective floor profile has a bulkhead or is designed as a gravity sealing or as a sealing, which reduces the design and construction effort on the wall arrangement as well as on the parking space. In addition, the sealing effect can be adjusted depending on the wall element by filling for the gravity sealing.

By filling the wall arrangement as a gravity sealing or as a sealing with extinguishing agent and/or with a gas or gas mixture, the design and construction effort on the wall arrangement can be reduced, at least with regard to sufficient sealing, as additional structural or constructional sealing can be dispensed with or can only be used to a reduced extent. In addition, depending on the ambient conditions, special static features can be taken into account by using extinguishing agents and a gas or gas mixture arranged in sections or areas. In addition to air, extinguishing gases or other suitable, preferably non-flammable or fire-retardant gases or gas mixtures can also be used as a gas or gas mixture.

Advantageously, at least one sensor and/or at least one parking aid and/or at least one overflow arrangement or filling level control is provided so that the vehicle is parked accordingly by means of the at least one sensor and/or the parking aid and this can also be monitored so as not to impede the function of the extinguishing arrangement and thus the movement of the wall arrangement or so as not to collide with the wall arrangement. Furthermore, the extinguishing agent consumption and/or extinguishing agent loss can be detected and/or recognized with the overflow arrangement or fill level control.

Furthermore, sensors can be provided to detect a fire or an excess temperature or smoke development or to detect gas indicating overheating or combustion.

In this way, sensors from the respective building technology can be used or integrated and, if necessary, supplemented with additional sensors. In this way, existing detection gaps can be closed for monitoring impending or incipient fires.

By filling the double-walled wall arrangement or the internal hollow chambers or the floor profile with the extinguishing agent or water, the design and construction work on the wall arrangement can be reduced, at least in terms of stabilization. Additional structural or constructional stabilization can be reduced or dispensed with.

The presence of openings in the area enclosed by the wall arrangement in the double-walled wall arrangement or in the internal hollow chambers or in the floor profile facilitates the equalization or distribution of extinguishing agent between the wall arrangement and the area enclosed by the wall arrangement, by allowing extinguishing agent to flow from the wall arrangement into the enclosed area when a certain filling level is reached in which the openings are arranged or, conversely, by allowing extinguishing agent to flow from the enclosed area through the openings into the wall arrangement, thereby further filling the wall arrangement depending on the filling level in the enclosed area.

Furthermore, it is advantageous for the wall arrangement to have at least one extinguishing agent inlet and/or at least one nozzle pointing towards the vehicle or at least one extinguishing agent outlet. This means that extinguishing agent, for example, in the form of a hydro shield for extinguishing or cooling, can be sprayed and/or flooding can begin as soon as the wall is moved from the standby position to the required position. In addition, the extinguishing hoses can be connected under the protection of the wall arrangement and flooding can be carried out directly and more easily with at least minimal loss.

By providing an extinguishing agent supply, the extinguishing system can be filled immediately or directly or extinguishing or cooling can begin. In this way, hoses or the extinguishing agent inlet can be connected or laid with little effort and a short length.

While the at least two modules of the wall arrangement are driven or lifted laterally around the vehicle as a mobile variant and set down on the parking space and connected to each other, extinguishing agent can already be sprayed by means of the nozzles, for example, in the form of a hydro shield for extinguishing or cooling.

As the respective modules of the wall arrangement can be folded or swiveled in several parts or assembled, the modules can be stowed and transported in a space-saving manner when not in use and set up in preparation at the place of use. Accordingly, the respective modules of the wall arrangement can be folded apart or swung apart for use and folded back into a more compact or space-saving form after use or swung together or taken apart or dismantled. The modules can also be adapted and combined to suit different vehicles or vehicle sizes.

For example, by providing rollers or wheels on the modules of the wall arrangement that are adjustable in position or height, the modules can be easily and purposefully moved to the vehicle and laterally enclose and align it and then lowered, for example, by lifting or swiveling away the wheels or rollers, whereby the modules of the wall arrangement are lowered and sit or rest or stand on a floor as a parking space.

According to a preferred design of the invention, at least two modules can be moved laterally around the vehicle at least in certain areas or sections, either manually or by means of a drive. This facilitates handling and personal protection.

According to an advantageous effect of the procedure, the area enclosed by the wall arrangement is flooded at least from the parking space at least up to the upper edge of the vehicle wheels or up to the upper edge of the electronics or the batteries or accumulators or at least up to the source of the fire. In this way, electric fires can be counteracted effectively and in a targeted and needs-based manner, particularly in electric vehicles.

According to an advantageous effect of the procedure, the wall arrangement can be extended, unrolled, unfolded and/or folded out at least in sections or from a ceiling or from a frame or a holder vertically downwards to or into the parking space, the respective vehicle can be enclosed from the ceiling to the parking space.

According to an advantageous effect of the procedure, by pulling, unfolding, unrolling and/or folding out an additional wall arrangement laterally or horizontally around and/or over the vehicle, at least in certain areas or sections, the respective vehicle can be enclosed on all sides from the side and from above.

By displacing or moving at least two modules of the wall arrangement at least in certain areas or sections with one drive each, the procedure and arrangement is simplified and personal protection is improved.

According to a preferred design of the invention, it is provided that after moving the wall arrangement into the required position, the intermediate space of a double-walled wall arrangement or internal hollow chambers or a gravity sealing is first filled or flooded with the extinguishing agent or with water. Filling favors the sealing of the wall arrangement towards the floor and, if necessary, improves the required stability of the wall arrangement.

By introducing or spraying extinguishing agent while the wall arrangement is moved at least in sections from a standby position to a required position and the vehicle is enclosed at least laterally, the vehicle can be cooled and, if necessary, a fire can be prevented or, in the event of a fire, the fire and its surroundings can be cooled.

Furthermore, extinguishing agent can already be sprayed and the surrounding area cooled when the respective modules of the wall arrangement are moved, which is advantageous for personal protection and firefighting.

### BRIEF DESCRIPTION OF THE DRAWINGS

Several advantageous effects of the invention are shown in the drawings and are described in more detail below.

The following is shown:

FIGS. 1A and 1B an extinguishing arrangement with a circular wall arrangement made of flexible, double-walled wall material,

FIG. 2 the schematic representation of a wall arrangement made of double-walled wall material in a groove-like recess,

FIG. 2 the schematic representation as a sectional view of a wall arrangement with double-walled wall material in a groove-like recess,

FIG. 3 the schematic representation with a wall arrangement in a double floor in the parking space,

FIG. 4A to 4C the schematic representation of an extinguishing arrangement with a wall arrangement on the side of the parking space as a platform,

FIG. 5A to 5D the schematic sectional view of an extinguishing arrangement with a wall arrangement with double-walled wall material in a groove-like recess,

FIGS. 6A and 6B are schematic sectional views of an extinguishing arrangement with a wall arrangement with double-walled wall material in a groove-like recess,

FIG. 7 an extinguishing arrangement with a circular wall arrangement made of flexible wall material,

FIG. 8 an extinguishing arrangement with a wall arrangement made of rigid wall material with a trough-shaped ballast area,

FIGS. 9 to 12A and 12B to 13 an extinguishing arrangement with a wall arrangement as a mobile variant with two modules in different views and detailed views and

FIGS. 14 to 19 an extinguishing arrangement with a wall arrangement as a mobile variant with two modules in different views and detailed views.

### DETAILED DESCRIPTION OF THE PREFERRED EMBODIMENTS

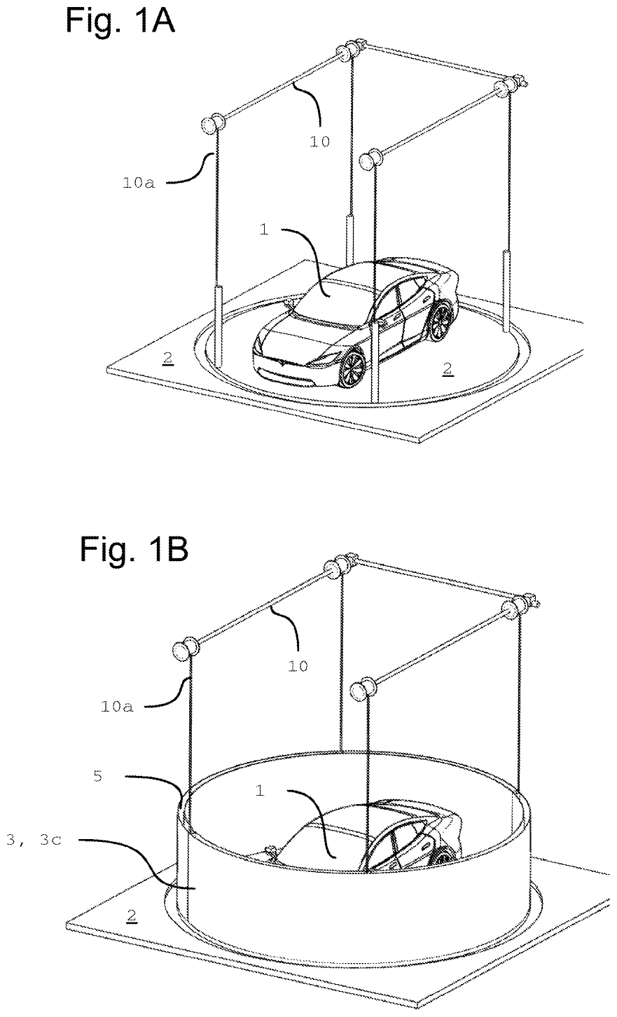

FIGS. 1A and 1B show an extinguishing arrangement according to the invention, which comprises a circular, generally movable wall arrangement 3 made of flexible, double-walled wall material 3a, which in the standby position is arranged folded together in a groove-like recess 6 embedded in the parking space 2. Above the installation area 2, cable winches 10 are arranged on a ceiling 13 or a frame (not shown) as an adjusting device 10 and connected to the double-walled, flexible, movable wall arrangement 3 by means of cables 10a. The wall arrangement 3 can be pulled upwards using the cable winches 10 as an adjusting device 10 and the cables 10a.

FIG. 1B shows a perspective view of the wall arrangement 3 made of flexible, double-walled wall material 3a pulled upwards into the required position. The double-walled, flexible wall material 3a pulled upwards thus forms a type of foil bag and therefore a double-walled, flexible, movable wall arrangement 3. The intermediate space 5 within the double-walled, flexible, movable wall arrangement 3a, 3a is filled with water 4 or extinguishing agent 4 as required.

The weight resulting from the filling presses the double-walled, flexible, movable wall arrangement 3 against the base of the groove-like recess 6 and against the radially lateral inner walls or inner sides in the groove-like recess 6 or onto the parking space 2, so that the sealing 11 is created there towards the parking space 2 and/or the groove-like recess 6. This double-walled flexible, movable wall arrangement 3 is circumferentially connected to one another or is circumferentially manufactured as a double-walled wall material 3a, for example, as a foil bag, so that the movable wall arrangement 3 can be filled with water 4 or another extinguishing agent 4.

In an improved version, the double-walled, flexible, movable wall arrangement 3 can have openings (not shown) at a certain height on the side facing the parking space 2, so that from this level the extinguishing agent 3 can flow from the intermediate space 5 into the area with the vehicle 1 enclosed by the movable wall arrangement 3a.

The double-walled, flexible, movable wall arrangement 3 is pulled upwards or vertically to the intended height by means of the adjusting device 10, designed as a cable winch 10, and the cables 10a. Subsequently, the intermediate space 5 within the double-walled, flexible, movable wall arrangement 3 is filled with water 4 or extinguishing agent 4 and subsequently the space within the double-walled, flexible, movable wall arrangement 3 is filled with extinguishing agent 4.

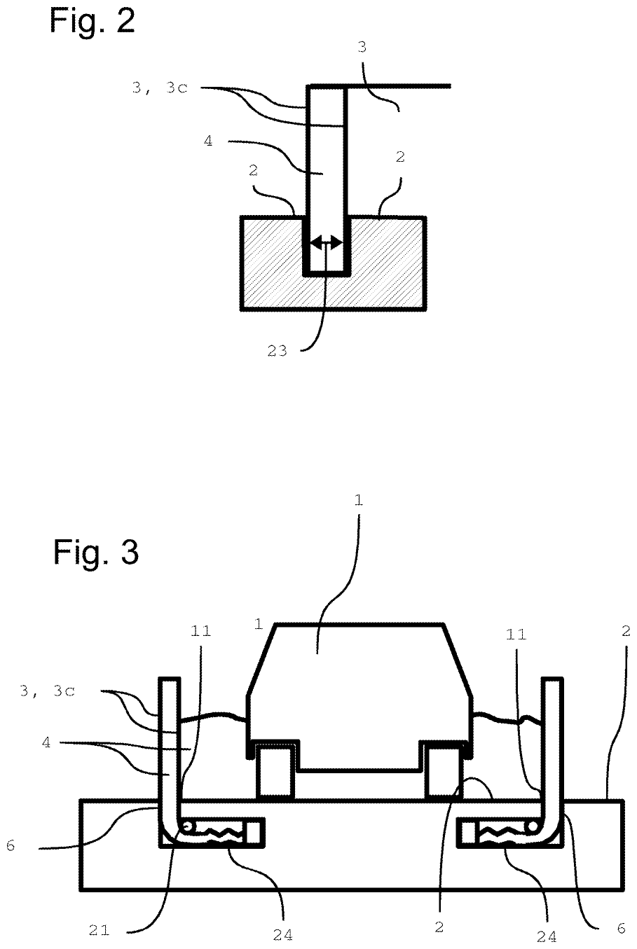

By arranging the double-walled, flexible, movable wall arrangement 3 in the groove-like recess 6, as shown in FIG. 2, a contact pressure 23 on the inner walls or inner sides of the groove-like recess 6 is realized in the required position by the filling and thus an improved sealing 11 to the groove-like recess 6 and to the parking space 2.

In FIG. 3, a movable wall arrangement 3 made of flexible wall material 3a, such as a foil 3a, is shown as an extinguishing arrangement. The double-walled foil 3a as wall arrangement 3 in this example is present all around and is accommodated folded together in a standby position in a double floor 24 under the parking space 2. A circumferential groove-like recess 6 is provided in the parking space 2, through which the wall arrangement 3 can be pushed from the standby position into the required position and laterally encloses the vehicle 1. The movable and circumferential wall arrangement 3 made of flexible wall material 3a as a foil bag wall can be filled with extinguishing agent 4 and seals against the parking space 2 as a gravity sealing 11. The wall arrangement 3 can be filled accordingly and thus raised to such an extent that extinguishing agent 4 can be filled inside the flexible wall material 3a at an appropriate height for firefighting. Inside and outside the wall arrangement 3, the parking space 2 is at the same level.

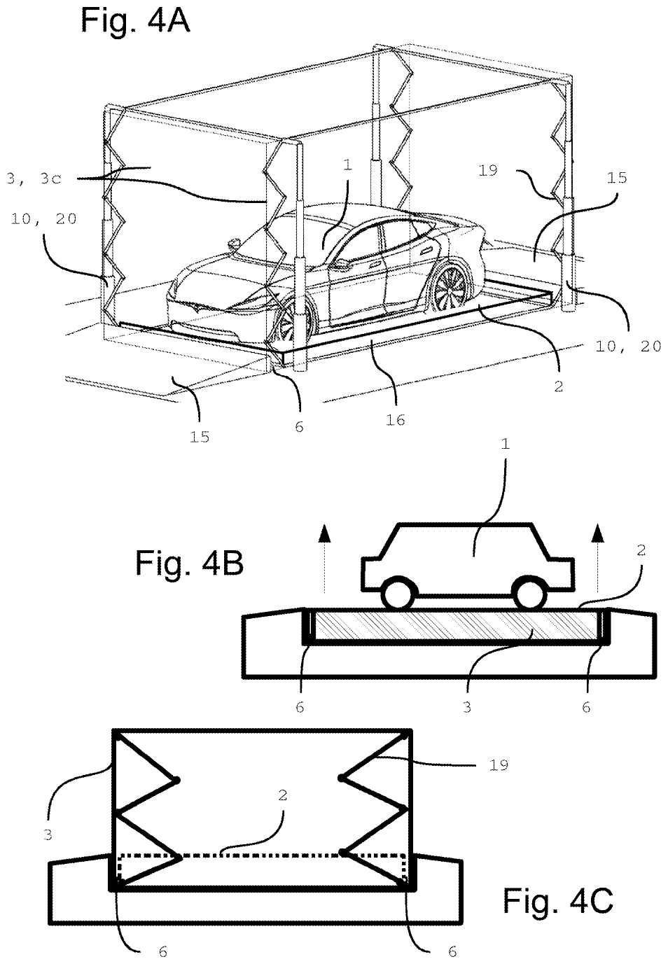

FIGS. 4A to 4C show an extinguishing arrangement with a movable wall arrangement 3 made of flexible wall material 3a, such as a foil 3a, in the required position; in this example, the single-layer foil 3a as wall arrangement 3 is present all the way around and, as shown in FIG. 4B, is stored folded up next to or around the parking space 2, which is designed as a platform 16, in the standby position. Ramps 15 leading onto the platform 16 are provided for driving onto or parking on the platform 16. A groove-like recess 6 is formed between platform 16 and ramp 15, in which the folded foil 3 of wall arrangement 3 is arranged. This compact version of the wall arrangement 3 is therefore also suitable for retrofitting. As shown in FIGS. 4A and 4C, the movable wall arrangement 3 made of flexible wall material 3a can be moved upwards into the required position as required by means of a scissors-lift mechanism 19 and/or by means of telescopic hydraulic cylinders 20. The movable and circumferential wall arrangement 3 made of flexible wall material 3a as a foil bag wall can accordingly be raised to such an extent that extinguishing agent 4 can be filled inside the flexible wall material 3a at an appropriate height for firefighting.

Alternatively, the movable wall arrangement 3 can also be double-walled and thus fillable.

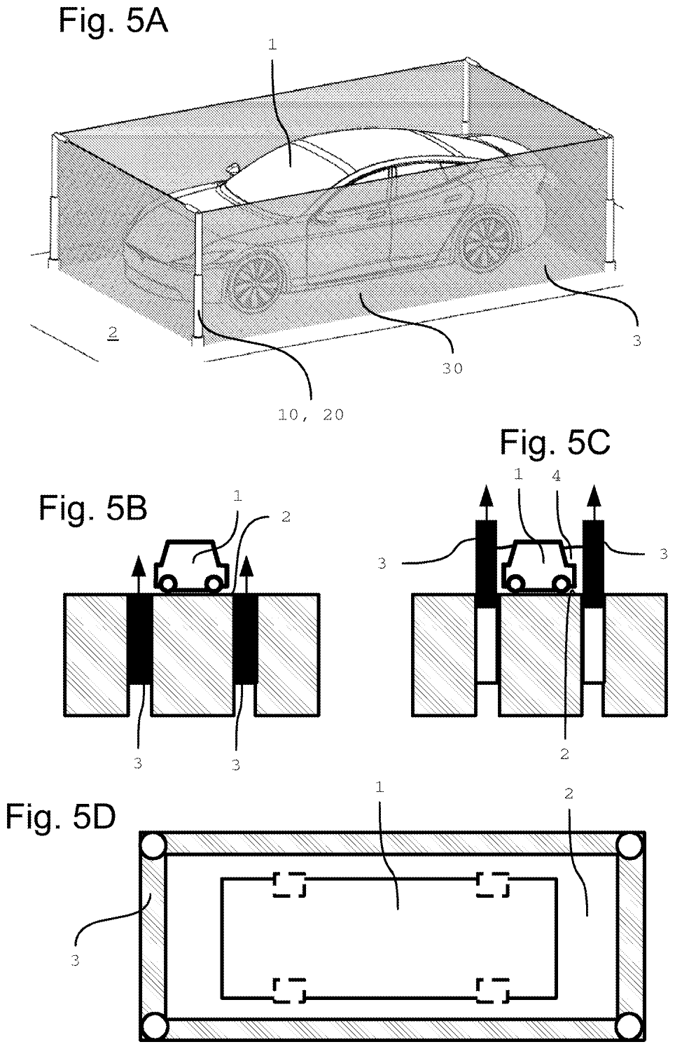

FIGS. 5A to 5D show an extinguishing arrangement in which the wall arrangement 3 is embedded in a groove-like recess 6 in the parking space 2. Here, as shown in FIG. 5D, four telescopic rods 20 with hydraulic or pneumatic cylinders or with a spindle drive are arranged as an adjusting device 10 distributed over the corners as a lifting system. When retracted, the telescopic rods 20 are lowered into the parking space 2. The flexible wall material 3a of the wall arrangement 3 comprises a plastic film which, as shown in FIG. 5B, is recessed or sunk into the groove-like recess 6 in the retracted state of the standby position. However, it can also lie folded up on the floor of the groove-like recess 6. As shown in FIG. 5C, the four supports are extended via the lifting system until the end position is reached. As a result, the flexible wall material 3a of the wall arrangement 3 is pulled upwards into the required position and thus stretched. Inside the plastic film, as shown schematically in FIG. 5A, there is a steel grid as a support structure 30, which gives the wall the necessary strength. Once the end position or required position is reached, the area enclosed by the wall arrangement 3 is filled with extinguishing agent 4 up to the maximum required height. The fire protection system regulates the extinguishing agent level until an authorized person assesses the situation and initiates the next steps.

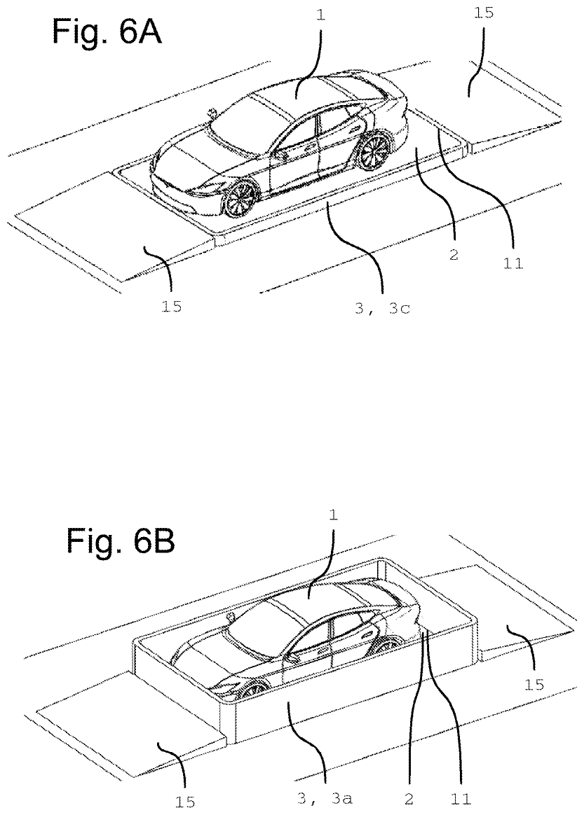

FIGS. 6A and 6B show a movable wall arrangement 3 made of flexible wall material 3a, whereby the flexible wall material 3a is double-walled. The wall arrangement 3 is arranged here around the parking space 2. The parking space 2 forms a platform 16, whereby ramps 15 are provided for access.

The wall arrangement 3 can be folded out or pushed out upwards using an internal adjusting device (not shown). The wall arrangement 3 has a sealing 11 to the parking space 2. In addition, reinforcements (not shown) can be provided that straighten up when unfolded or pushed out.

The wall arrangement 3 can also be pushed upwards into the required position by filling an internal hollow chamber (not shown) with water 4 or extinguishing agent 4 or another filling material, as shown in FIG. 6B. The filling weight creates a gravity sealing 11 to the floor 12.

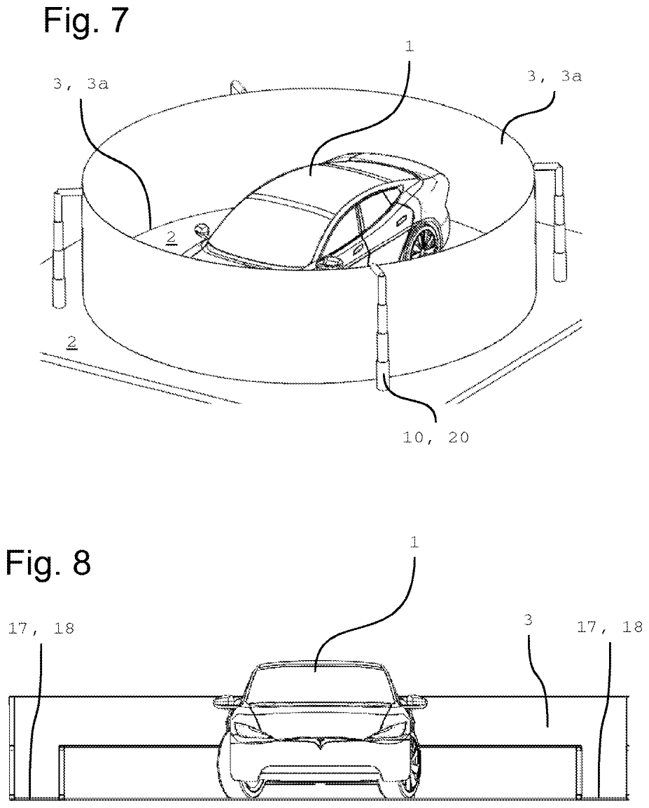

FIG. 7 shows an extinguishing arrangement according to the invention, which comprises a circular, generally movable wall arrangement 3 made of flexible wall material 3a, which in the standby position is folded into an annular groove 6 (not shown) recessed into the parking space 2. Telescopic rods 20 with hydraulic or pneumatic cylinders or with a spindle drive are distributed as a lifting system in the parking space 2 outside the wall arrangement 3 as an adjusting device 10. The wall arrangement 3 can be pulled upwards into the required position using the lifting system.

A sealing 11 is provided between the wall arrangement 3 and the groove-like recess 6 or the parking space 2.

FIG. 8 shows a sectional view of an extinguishing arrangement according to the invention, in which the wall arrangement 3, for example, as a mobile variant, comprises four modules 12, each of which is arranged from the standby position to the required position and can be connected and/or joined at the corners and enclose the vehicle 1, wherein the modules 12 each have a floor profile 17 resting on the parking space 2 as a ballast tray 18, which is connected to the wall arrangement 3 or merges into it, wherein the ballast tray 18 is arranged within the area enclosed by the wall arrangement 3. Bulkheads 11 (not shown) are provided between each of the modules 12 at the corners. Advantageously, the ballast tray 18 is flooded first and the area with the vehicle 1 is flooded after it has overflowed or parallel to it. The ballast tray 18 forms a gravity sealing 11. In addition, a bulkhead 11 can be provided on the underside. The four modules 12 extend upwards from the floor profile 17 like a wall and are pre-assembled, whereby at least two modules 12 can be moved or lifted laterally around the vehicle 1 and can be set down on the parking space 2 and connected to each other.

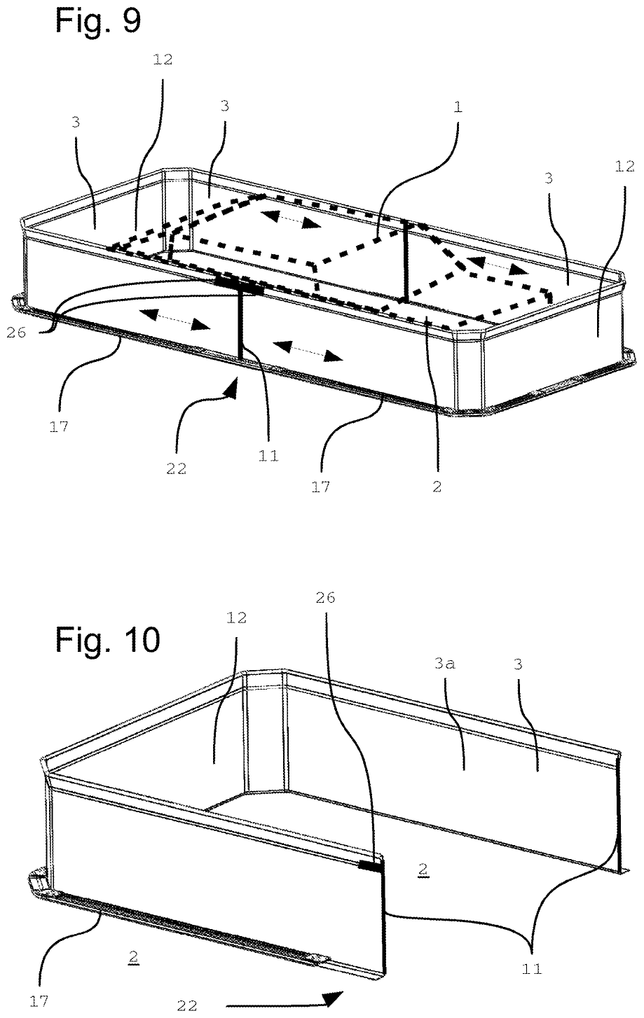

A further extinguishing arrangement according to the invention as a mobile variant for parked vehicles 1, in particular for electric vehicles, and details thereof are shown in FIGS. 9 to 13.

A wall arrangement 3 can be erected around the respective vehicle 1 parked on a parking space 2, which is designed to surround or enclose the vehicle 1 at least laterally in such a way as to receive and/or retain an extinguishing agent 4 at least in the enclosed area and to surround and/or flood the vehicle 1 with the extinguishing agent 4 at least in certain areas. Starting from a standby position, the wall arrangement 3 is designed to enclose the vehicle 1 at least laterally in a required position. As a mobile variant, the wall arrangement 3 comprises two U-shaped modules 12, each of which has a floor profile 17 resting on the parking space 2. As shown in FIGS. 9 and 10, two modules 12 extend upwards from the floor profile 17 like a wall and are pre-assembled.

As an alternative to the U-shape, the modules 12 can also be L-shaped, which when assembled or arranged also form a U-shape or an essentially rectangular shape, which form the extinguishing arrangement that encloses the respective vehicle 1.

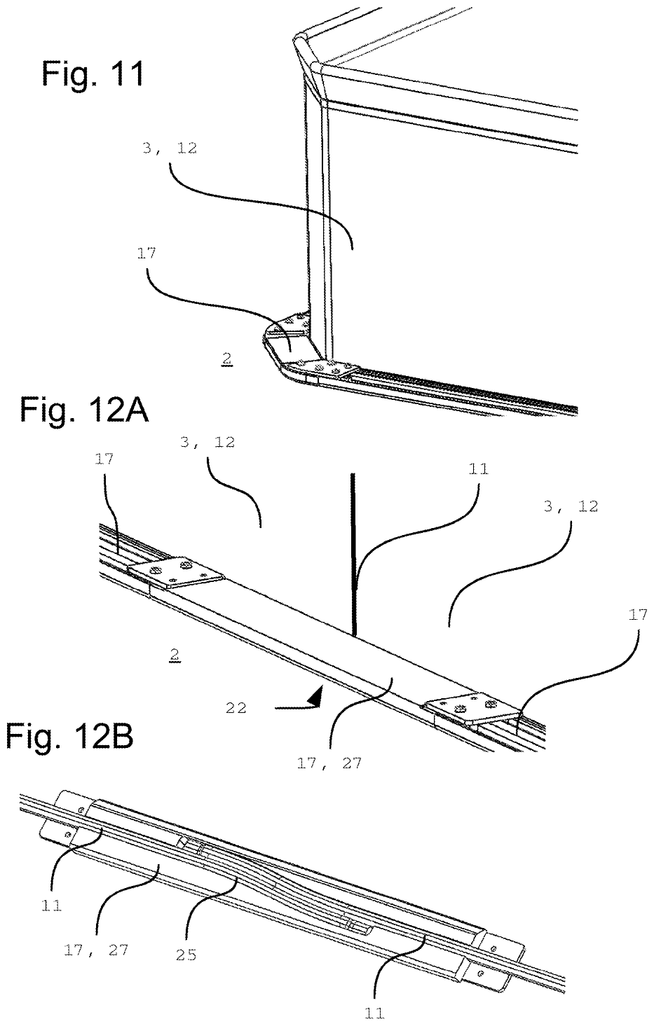

The floor profile 17 is oriented outwards, outside the area enclosed by the wall arrangement 3. As shown in FIG. 11, the floor profile 17 is composed of several parts and has a continuous bulkhead 11 for each module 12. In the connection area 22 or contact area 22 of the two modules 12 arranged next to each other, the bulkhead 11 is longer or protruding in each case. The bulkheads 11 can be arranged next to each other in an overlapping manner. To ensure a secure position and sealing effect, the floor profile 17 has a connecting profile 27 with a guide 25 for the bulkheads 11. The connecting profile 27 of the floor profile 17 with the guide 25 is shown in FIG. 12A and from below in FIG. 12B.

The two U-shaped modules 12 can be lifted from the standby position laterally, for example, in the direction of the arrow shown around the vehicle 1, into the required position and can be set down on the parking space 2 and connected to one another. Accordingly, the modules 12 can be removed from the vehicle 1 in the opposite direction of the arrow.

Accordingly, two or four L-shaped modules 12 can also be lifted or displaced or moved laterally around the vehicle 1 from the standby position into the required position and lowered onto the parking space 2 and connected to one another.

Mixed forms of U-shaped and L-shaped modules 12 can also form the extinguishing arrangement.

FIG. 10 shows a single module 12 of the wall arrangement 3 as shown in FIG. 9. A bulkhead 11 is present at the edges in the connection area 22 or contact area 22 to a module 12 that can be arranged thereon, at least in the wall-like upwardly extending area of the wall arrangement 3.

The wall arrangement 3 has a flexible wall material 3a reinforced with a metal mesh (not shown), which has additional reinforcements and stiffeners (not shown), particularly at the upper edge and in the corner areas.

The modules 12 can be reliably connected using fastening means 26 or interlocks 26, as shown for example, in FIGS. 9 and 10. A further connection is realized via the connecting profile 27 of the floor profile 17. Additional fastening means 26 or interlocks 26 can also be provided. For this purpose, the wall arrangement 3 preferably has further reinforcements (not shown) in this area.

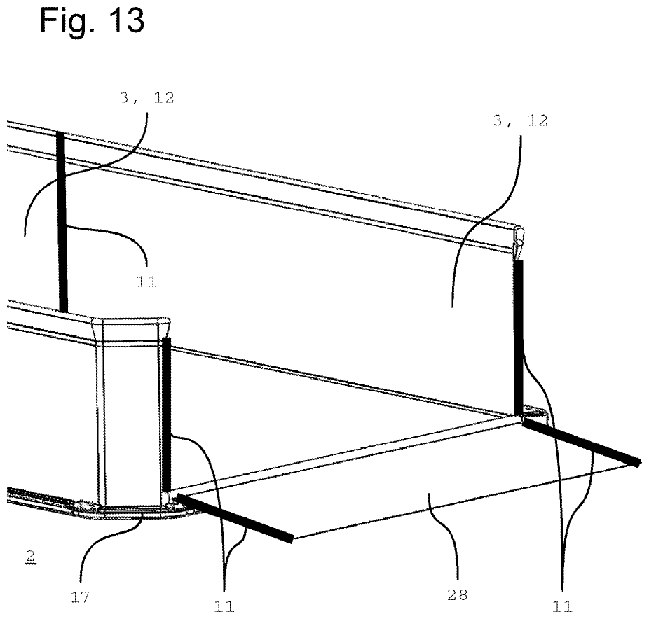

The module 12 shown in FIG. 13 can have a hinged or pivotable wall section 28 in a wall arrangement 3 as a mobile variant. In the closed state, the pivoting wall section 28 is sealed off from the fixed wall arrangement 3 by means of a bulkhead 11.

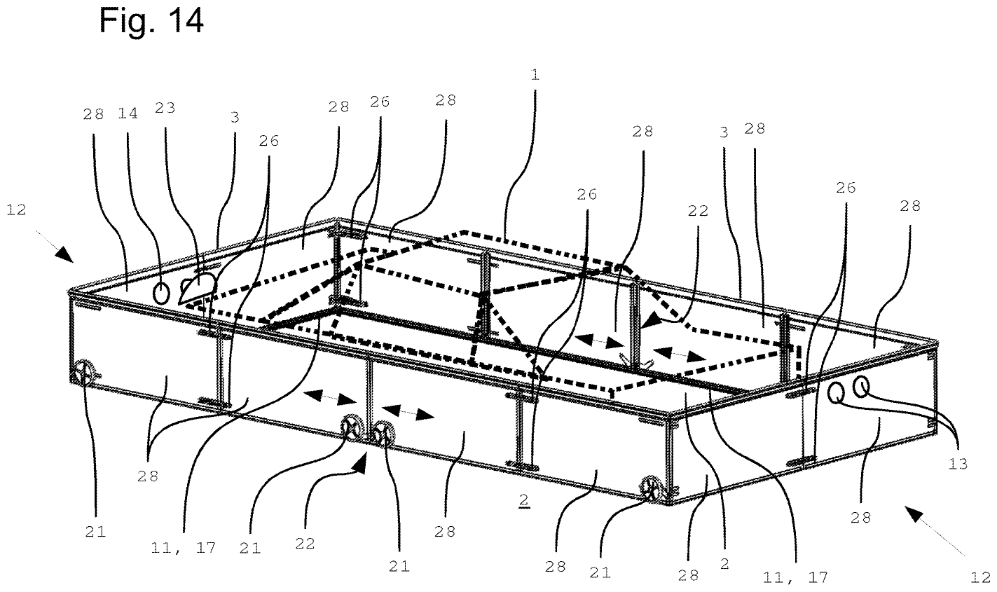

FIGS. 14 to 19 show a further extinguishing arrangement according to the invention as a mobile variant for parked vehicles 1, in particular for electric vehicles, as well as details thereof.

In the extinguishing arrangement according to the invention as a mobile variant for parked vehicles 1 shown in FIG. 14, a wall arrangement 3 can be erected around the respective vehicle 1 parked on a parking space 2. Vehicle 1 is laterally surrounded or enclosed in such a way as to receive and/or retain an extinguishing agent 4 in the enclosed area thus formed, thereby surrounding and/or flooding vehicle 1 with the extinguishing agent 4 at least in certain areas. The wall arrangement 3 can be moved from a standby position away from the vehicle 1 into a required position around the vehicle 1 and thus encloses the vehicle 1 laterally, i.e. from the front, rear right and left. In the specific example, the wall arrangement 3 as a mobile variant comprises two modules 12, each of which has a floor profile 17 resting on the parking space 2 with a supporting hollow profile 29 arranged thereon and a bulkhead 11 arranged on the floor profile 17. The floor profile 17, the hollow profile 29 and the bulkhead 11 are arranged within the enclosed area or on the side of the wall arrangement 3 facing the vehicle 1.

The wall arrangement 3 of the respective modules 12 is multi-part and hinged. In the specific example, there are six wall sections 28 per module 12, which are connected to one another via fastening means 26 and interlocks 26. The fastening means 26 and interlocks 26 are designed to pivot accordingly.

The number of modules 12 can vary. Thus, four or six modules 12 can also be arranged and connected accordingly. The modules 12 can also comprise different numbers of wall sections 28.

The wall arrangement 3 or the wall sections 28 of the modules 12 extend upwards from the floor profile 17 like a wall and are pre-assembled. In this specific example, sheet metal is used as the material for the floor profiles 17 and wall sections 28. Profiles are provided as reinforcements 31 in the area of the vertical outer edges of the wall sections 28. From a standby position, the modules 12, which are already folded out and locked for this purpose, can be moved laterally around the vehicle 1 into the required position using wheels 21, which are also folded out or lowered for this purpose. By folding up or folding in or raising the wheels 21, the respective modules 12 can be lowered onto the parking space 2 and connected to each other. It is intended that either the modules 12 are connected to each other before the respective modules 12 are set down on the parking space 2 or that the respective modules 12 are first set down on the parking space 2 and then the modules 12 are connected to each other.

FIG. 14 shows that the wall arrangement is completely assembled in the required position, is set down on the parking space 2 and encloses a vehicle 1.

Furthermore, an extinguishing agent supply is provided, which is routed to two extinguishing agent inlets 13. One extinguishing agent inlet 13 is directly connected to an extinguishing agent outlet 14, which points towards the vehicle 1 or into the area enclosed by the wall arrangement 3. Another extinguishing agent inlet 13 is connected to a nozzle 23. The nozzle 23 can be used to create a hydro shield when moving or lifting the vehicle, which cools the fire and thus protects the surrounding area and the emergency services.

Two modules 12 can be moved laterally from the standby position, for example, in the direction indicated by the arrow, around the vehicle 1 to the required position and can be set down on the parking space 2 and connected to each other. Accordingly, the modules 12 can be removed or moved away from the vehicle 1 in the opposite direction of the arrow.

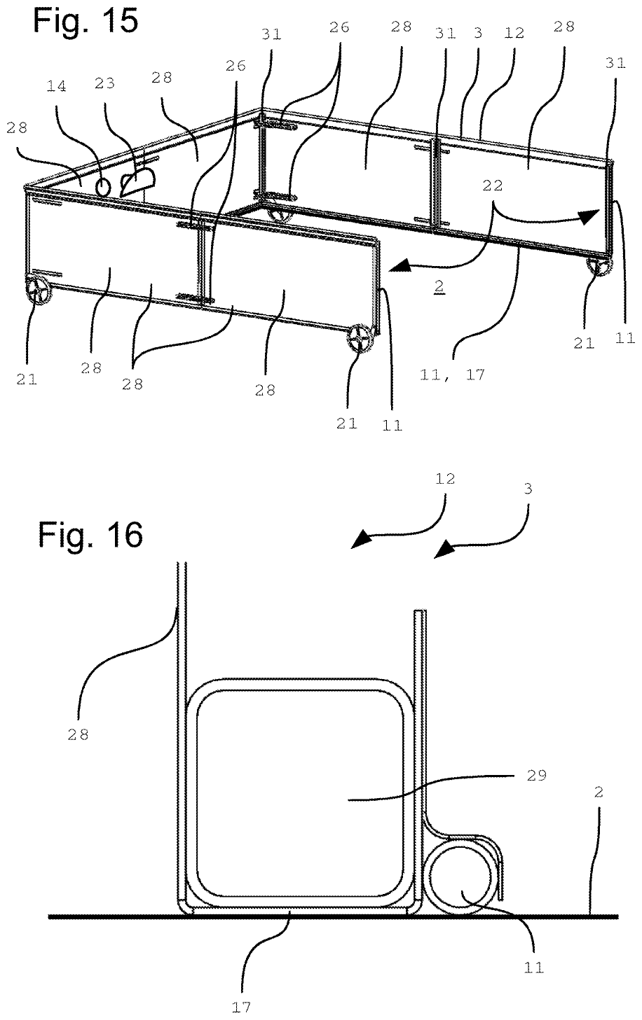

Deviating from and supplementing the explanations in FIG. 14, FIG. 15 shows a single module 12 of a wall arrangement 3 in which the wheels 21 are folded out or lowered. Bulkheads 11 are provided at the edges or the reinforcements 31 of the individual adjacent wall sections 28 and at the connecting area 22 or contact area 22 to a further module 12.

FIG. 16 shows a sectional view of the floor profile 17 with a supporting hollow profile 29 arranged thereon and the bulkhead 11 arranged on the floor profile 17. The floor profile 17 and the bulkhead 11 rest on the parking space 2. The wall section 28 of the wall arrangement 3 or the module 12 extends upwards wall-like from the floor profile 17. The hollow profile 29 can be filled with the extinguishing agent 4 or another ballast as part of the floor profile 17. The bulkhead 11 can also be filled or pressurized from the inside.

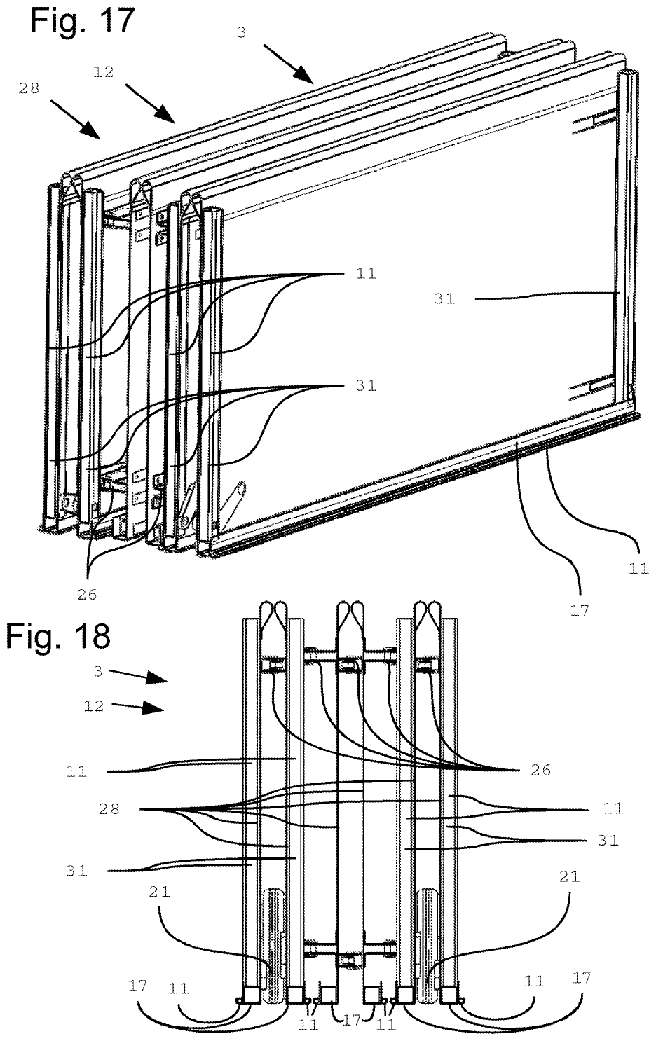

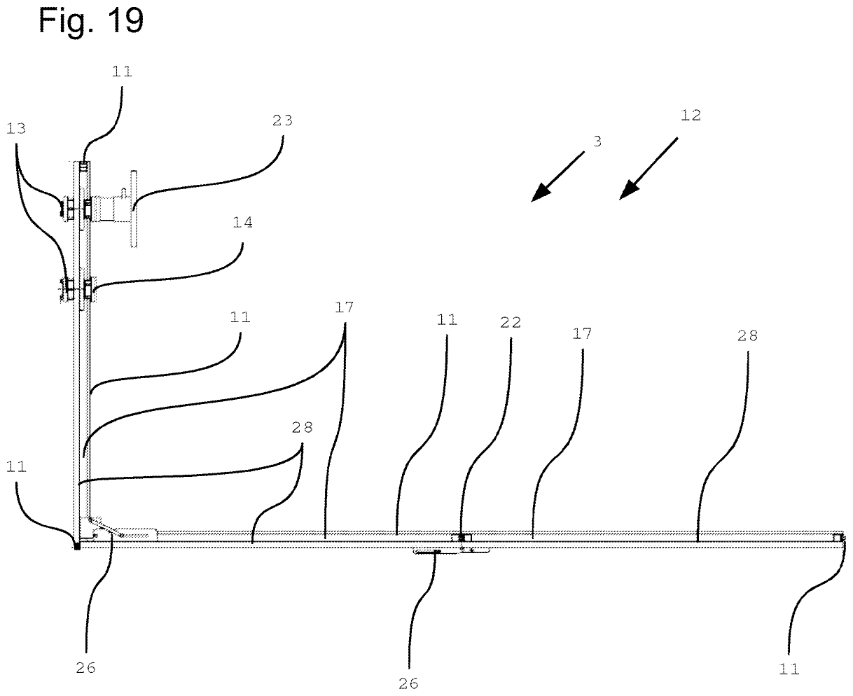

FIGS. 17 and 18 show folded modules 12 of the wall arrangement 3, such as can be accommodated in emergency vehicles of the rescue services.

The individual wall sections 28 of the wall arrangement 3 or of the module 12 with the floor profiles 17 and the bulkheads 11 at the edges or the reinforcements 31 are connected via pivotable fastening means 26 or interlocks 26, so that the wall sections 28 can be folded out and in on the one hand and fixed on the other.

FIG. 19 shows a top view of an L-shaped module 12 comprising three wall sections 28 of the wall arrangement 3. One wall section 28 has two extinguishing agent inlets 13, which are guided to an extinguishing agent outlet 14 and a nozzle 23. Fastening means 26 or interlocks 26 and bulkheads 11 are provided in the corner area of the corner and in the connecting area 22 of the two longitudinally adjacent wall sections 28. Bulkheads 11 are also provided at the connecting areas 22 to other adjacent modules 12 with wall sections 28 of the wall arrangement 3.

When using this module 12, for example, four modules 12 are required to construct a wall arrangement 3 of the extinguishing arrangement enclosing the respective vehicle 1, each of which can be moved or lifted laterally around the vehicle 1 and set down on the parking space 2 and can be connected to one another.

The wheels 21 or rollers 21 can also have a drive for moving the modules 12.

All the features of the designs shown and described can be combined with one another as far as possible or expedient.

In particular, all flexible wall arrangement 3 or the wall sections 28 can be single-walled or double-walled and thus fillable. The flexible wall arrangement 3 or the wall sections 28 or the flexible wall material 3a can be reinforced with fabric, steel wire or steel mesh, whereby these reinforcing structures can be integrated into the flexible wall material 3a or arranged outside the flexible wall material 3a as support structures 30. Slidable lattice grates can be arranged on the outside or inside as reinforcing structures.

The movement or displacement of the movable wall arrangement 3 or the wall sections 28 can also be carried out manually or by means of adjusting devices of different designs, in addition to adjusting devices 10 of different designs. The movement of the wall arrangement 3 or the wall sections 28 and the filling with extinguishing agent 4 or water 4 can be automated by detecting the need using suitable sensors.

Parking aids, for example, by means of light barriers, can be provided to ensure that the vehicle 1 does not protrude beyond the parking space 2 and thus does not interfere with any necessary movement of the wall arrangement 3 or the wall sections 28.

A float/level sensor can be used to regulate the fill level of the water 4 or extinguishing agent 4.

The procedure according to the invention for extinguishing or cooling a stationary vehicle 1, in particular an electric vehicle, provides that the respective vehicle 1 stands on a parking space 2 and, upon detection of a fire or an excess temperature or smoke development or gas detection, a wall arrangement 3 is erected or positioned at least in certain areas around the vehicle 1 standing on the parking space 2. The vehicle 1 is enclosed at least laterally and the area enclosed by the wall arrangement 3 is flooded with an extinguishing agent 4. The extinguishing agent 4 surrounds the vehicle 1 at least in certain areas and/or it is flooded. To enclose the vehicle 1, the wall arrangement 3 is moved at least in sections from a standby position to a required position and the vehicle 1 is enclosed at least laterally.

In a design of the procedure, the wall arrangement 3 is pushed, pulled, rolled out and/or unfolded into the required position at least in some areas or in sections by means of a adjusting device 10 or by filling with an extinguishing agent 4 from the standby position from the parking space 2 or from laterally below the parking space 2 vertically or upwards.

In another design, at least two modules 12 of the wall arrangement 3 are moved or lifted from the standby position laterally around the vehicle 1 into the required position as a mobile variant 4 of the extinguishing arrangement and set down on the parking space 2 and connected to each other.

Advantageously, extinguishing agent 4 can already be introduced or sprayed while the wall arrangement 3 is moved at least in sections from the standby position to the required position and the vehicle 1 is enclosed at least laterally. In the mobile variant in particular, this can reduce the risk to the emergency services.

In both designs, an additional floor, for example, a plastic sheet or floor foil, is not required.

Furthermore, the area enclosed by the wall arrangement 3 is flooded at least from the parking space 2, for example, up to the upper edge of the vehicle wheels or up to the upper edge of the electronics or the batteries or accumulators or at least up to the source of the fire.

After moving the wall arrangement 3 into the required position, the intermediate space 5 of a double-walled wall arrangement 3 or internal hollow chambers or a gravity sealing 11 can first be filled or flooded with the extinguishing agent 4 or with water 4, after which the enclosed area is then flooded or flooded with a delay.

Furthermore, an additional wall arrangement 3 (not shown) can be provided, which can be pulled out, unrolled, unfolded and/or folded out at least in certain areas or sections from a ceiling or from a frame or a support vertically from above to or into the parking space 2.

This additional wall arrangement 3 can additionally or alternatively also be pulled, unfolded, rolled out and/or folded out laterally or horizontally around the vehicle 1.

Likewise, the additional wall arrangement 3 can additionally or alternatively be pulled out, unrolled, unfolded and/or folded out over the vehicle 1.

### LIST OF REFERENCE NUMERALS

1—Vehicle
2—Parking space
3—Wall arrangement
3a—flexible wall material, foil
4—Extinguishing agent, water
5—Intermediate space
6—groove-like recess
10—Adjusting device, cable winch
10a—Rope
11—Sealing, bulkhead, gravity sealing
12—Module
13—Extinguishing agent inlet
14—Extinguishing agent outlet
15—Ramp
16—Platform
17—Floor profile
18—Ballast tray
19—Scissors-lift mechanism
20—Hydraulic cylinder, telescopic rod
21—Roller, wheel
22—Connection area, contact area
23—Nozzle
24—double floor
25—Guide
26—Fastening mean, interlock
27—Connecting profile
28—Wall section
29—Hollow profile
30—Support structure
31—Reinforcement

1. Extinguishing arrangement for parked vehicles (1), in particular for electric vehicles, wherein the respective vehicle (1) is parked or can be parked on a parking space (2), wherein a wall arrangement (3) can be erected around the vehicle, which is designed to surround or enclose the vehicle (1) at least laterally in such a way to receive and/or retain an extinguishing agent (4) at least in the enclosed area and to surround and/or flood the vehicle (1) with the extinguishing agent (4) at least in certain areas, and in that the wall arrangement (3) is designed to enclose the vehicle (1) at least laterally starting from a standby position in a required position, characterized in
that the wall arrangement (3) comprises at least two modules (12) as a mobile variant, the modules (12) each having a floor profile (17) resting on the parking space (2) and at least two modules (12) extending upwards from the floor profile (17) in the manner of a wall and being preassembled, at least two modules (12) being movable or liftable laterally around the vehicle (1) from the standby position into the required position and being lowerable onto the parking space (2) and being connectable to one another
or
that the wall arrangement (3) in the standby position is recessed at least partially or in sections in the parking space (2) or is arranged laterally below the parking space (2) and can be pushed, pulled, rolled out and/or folded out vertically or upwards into the required position by means of an adjusting device (10) or by filling from the parking space (2) or from the side of the parking space (2).

2. Extinguishing arrangement according to claim 1,
characterized in
that the wall arrangement (3) is in one or more parts and comprises wall sections (28) or a curtain or a foil bag or a foil (3a).

3. Extinguishing arrangement according to claim 1,
characterized in
that additionally a wall arrangement (3) can be pulled, unrolled, folded down, unfolded and/or folded out vertically from above to or into the parking space (2) at least in sections or sections from a ceiling or from a frame or a holder
and/or
can be extended, unrolled, unfolded or folded out laterally or horizontally around the vehicle (1)
and/or
can be pulled out, unrolled, unfolded and/or folded out above the vehicle (1).

4. Extinguishing arrangement according to claim 1,
characterized in
that the wall arrangement (3) has a rigid or stiff construction and/or a foldable or hinged construction, at least in regions or sections.

5. Extinguishing arrangement according to claim 1,
characterized in
that the wall arrangement (3) is flexible or foldable or windable, wherein the wall arrangement (3) is single-walled or at least double-walled or has at least one internal hollow chamber
and/or in that the wall arrangement (3) has supporting structures (30), reinforcements (31) or stiffeners or coatings
and/or that support structures (30), reinforcements (31) or stiffeners independent of the wall arrangement (3) are present.

6. Extinguishing arrangement according to claim 1,
characterized in
that the parking space (2) has a groove-like recess (6), a platform (16) and/or a double floor (24) at least in some areas, the wall arrangement (3), which can be pulled out upwards, rolled out and/or folded out, being provided in the groove-like recess (6), in, on or under the platform (16) and/or in the double floor (24).

7. Extinguishing arrangement according to claim 1,
characterized in
that a ramp (15) leading onto the parking space (2) is provided, wherein the ramp (15) is independent of the parking space (2) or is part of the wall arrangement (3).

8. Extinguishing arrangement according to claim 1,
characterized in
that the wall arrangement (3) or the respective module (12) or floor profile (17) can be sealed or is sealed to the parking space (2) or is connected to the parking space (2) and/or in that the wall arrangement (3) or the respective module (12) or floor profile (17) has a bulkhead (11) or is designed as a gravity sealing (11) or as a sealing (11).

9. Extinguishing arrangement according to claim 1,
characterized in
that the bulkhead (11) or the wall arrangement (3) is filled with extinguishing agent (4) and/or with a gas or gas mixture as a gravity sealing (11) or as a sealing (11).

10. Extinguishing arrangement according to claim 1,
characterized in
that a sensor and/or a parking aid and/or an overflow arrangement or filling level control is present.

11. Extinguishing arrangement according to one of the claim 1,
characterized in
that the double-walled wall arrangement (3) or the internal hollow chambers or the floor profile (17) can be filled with the extinguishing agent (4) or water (4) and/or that openings are provided in the double-walled wall arrangement (3) or in the internal hollow chambers or in the floor profile (17) in the area enclosed by the wall arrangement (3).

12. Extinguishing arrangement according to claim 1,
characterized in
that the wall arrangement (3) has at least one extinguishing agent inlet (13) and/or at least one nozzle (23) pointing towards the vehicle (1) or at least one extinguishing agent outlet (14) and/or that one and one extinguishing agent supply is provided.

13. Extinguishing arrangement according to claim 1,
characterized in
that the respective modules (12) of the wall arrangement (3) can be folded or pivoted or assembled in several parts
and/or
that rollers (21) or wheels (21) are provided on the modules (12) of the wall arrangement (3), which are adjustable in position or height
and/or
that at least two modules (12) can be moved laterally around the vehicle (1) at least in certain areas or sections manually or by means of a drive.

14. Procedure for extinguishing or cooling a vehicle (1) parked or at a standstill, in particular an electric vehicle, wherein the respective vehicle (1) is parked or can be parked on a parking space (2), preferably using the extinguishing arrangement according to claim 1,
characterized in
that, when a fire or an excess temperature or smoke development or gas detection is detected, a wall arrangement (3) is erected or positioned at least in certain areas around the vehicle (1) standing on the parking space (2) and the vehicle (1) is enclosed at least laterally and the area enclosed by the wall arrangement (3) is flooded with an extinguishing agent (4) and the extinguishing agent (4) surrounds and/or floods the vehicle (1) at least in certain areas, wherein the wall arrangement (3) is moved at least in sections from a standby position into a required position and the vehicle (1) is enclosed at least laterally,
that at least two modules (12) of the wall arrangement (3) are moved or lifted as a mobile variant from the standby position laterally around the vehicle (1) into the required position and set down on the parking space (2) and connected to one another or
by pushing, pulling, rolling out and/or unfolding the wall arrangement (3) vertically or in sections from the standby position by means of an adjusting device (10) or by filling from the parking space (2) or from laterally below the parking space (2) into the required position at the top.

15. Procedure according to claim 14,
characterized in
that the area enclosed by the wall arrangement (3) is flooded at least from the parking space (2) at least up to the upper edge of the vehicle wheels or up to the upper edge of the electronics or the batteries or accumulators or at least up to the source of the fire.

16. Procedure according to claim 14,
characterized in
that an additional wall arrangement (3) is at least partially or in sections is dropped, pulled out, unrolled, unfolded and/or folded out vertically from above of a ceiling or from a frame or a support up to or into the parking space (2)
and/or
is pulled sideways or horizontally around the vehicle (1), unfolded, rolled out and/or folded out
and/or
is pulled out, unrolled, unfolded and/or folded out over the vehicle (1).

17. Procedure according to claim 14,
characterized in
that at least two modules (12) of the wall arrangement (3) are moved or displaced at least partially or in sections by means of a drive in each case.

18. Procedure according to claim 14,
characterized in
that after moving the wall arrangement (3) into the required position, the intermediate space (5) of a double-walled wall arrangement (3) or internal hollow chambers or a gravity sealing (11) is first filled or flooded with the extinguishing agent (4) or with water (4).

19. Procedure according to claim 14,
characterized in
that while the wall arrangement (3) is moved at least in sections from a ready position into a required position and the vehicle (1) is enclosed at least laterally, extinguishing agent (4) is injected or sprayed.
